(19) United States
(12) Patent Application Publication
(10) Pub. No.: US 2004/0160999 A1
(43) Pub. Date: Aug. 19, 2004

(54) Unit for stabilizing wavelength of laser beams and module for stabilizing wavelength of optical signal in optical communication

(75) Inventor: Shigenori Satou, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC COMPOUND SEMICONDUCTOR DEVICES, LTD.

(21) Appl. No.: 10/776,204

(22) Filed: Feb. 12, 2004

(30) Foreign Application Priority Data
Feb. 14, 2003 (JP) 2003-036899

(51) Int. Cl. H01S 3/13

(52) U.S. Cl. 372/32

(57) ABSTRACT

A unit for stabilizing a wavelength of a light, includes (a) a first light-receiver directly receiving a part of laser beams irradiated from a semiconductor laser, (b) a wavelength-filter directly receiving a part of the laser beams, and having a transmittance varying in accordance with a wavelength of the received laser beams, and (c) a second light-receiver receiving laser beams having passed through the wavelength-filter, wherein the first light-receiver has a first edge, and the second light-receiver has a second edge located in the vicinity of the first edge, and the first edge has a first linear portion and the second edge has a second linear portion extending in parallel with the first linear portion.

### BACKGROUND OF THE INVENTION

1. Field of the Invention

The invention relates to a unit for stabilizing a wavelength of laser beams irradiated from a semiconductor laser, and further to a module for stabilizing a wavelength of an optical signal in optical communication.

2. Description of the Related Art

A semiconductor laser is usually used as a light-source in an optical-fiber communication system. In particular, in an optical-fiber communication in a distance of tens of kilometers or more, a uniaxial mode semiconductor laser such as a distribution feedback (DFB) laser is used in order to suppress influence caused by wavelength dispersion.

A DFB laser oscillates at a single wavelength, and an oscillation wavelength thereof varies in accordance with a temperature and/or an operation current of the laser.

It is also important in an optical-fiber communication system to keep an intensity of laser beams irradiated from a light-source constant. Hence, existing optical-fiber communication systems are usually designed to include a controller for keeping constant a temperature of a semiconductor laser and an intensity of laser beams irradiated from a semiconductor laser. Fundamentally, an oscillation wavelength and an intensity of laser beams can be kept constant by keeping constant a temperature of a semiconductor laser and a current introduced into a semiconductor laser.

Long use of a semiconductor laser causes degradation in elements constituting the semiconductor laser. As a result, an operation current of a semiconductor laser has to be increased in order to keep an intensity of laser beams irradiated from the semiconductor laser constant, and hence, an oscillation wavelength of a semiconductor laser varies. However, since an oscillation wavelength varies quite slightly, such variance in an oscillation wavelength does not cause a problem in a conventional optical-fiber communication system.

Recently, a densification wavelength division multiplexing (DWDM) system in which a plurality of lights having different wavelengths from one another is introduced into a single optical fiber is predominantly used in an optical-fiber communication, and in addition, a gap between wavelengths selected in the optical-fiber communication becomes smaller, specifically, a gap is 100 GHz or 50 GHz. In such an optical-fiber communication, a semiconductor laser used as a light-source is required to have wavelength stability of ±50 pm per 25 years, for instance. Thus, the conventional control of keeping constant a temperature of a semiconductor laser and an intensity of laser beams irradiated from a semiconductor laser cannot provide sufficient wavelength stability to a semiconductor laser.

Even if elements constituting a semiconductor laser are kept constant at a temperature, there would be caused a problem that an oscillation wavelength of a semiconductor laser slightly varies, if an ambient temperature around a semiconductor laser varies.

In order to prevent variance in an oscillation wavelength of a semiconductor laser, many apparatuses for stabilizing a wavelength of laser beams irradiated from a semiconductor laser have been suggested, for instance, in Japanese Patent Application Publications 10-209546 and 10-79723 the latter of which is based on U.S. patent application Ser. No. 08/680,284 filed on Jul. 11, 1996.

However, the apparatuses suggested in the above-identified Publications are accompanied with problems that since they are comprised of a lot of parts and thus occupy a large space, they cannot be accommodated in a case in which a conventional semiconductor laser module could be accommodated, and that it is quite difficult to set a wavelength equal to a standard wavelength as a target wavelength for stabilization with the result of much increase in fabrication costs of a semiconductor laser.

Japanese Patent Application Publication No. 2001-257419 has suggested a module for stabilizing a wavelength of laser beams which module is capable of solving the above-mentioned problems. The suggested module provides high accuracy, and is comprised of parts in a smaller number than a conventional semiconductor laser module, and resultingly, occupies a smaller space than a conventional semiconductor laser module.

FIG. 1 is an upper plan view of the module for stabilizing a wavelength of laser beams, suggested in Japanese Patent Application Publication No. 2001-257419.

The illustrated module 500 is comprised of a semiconductor laser 501, a lens 502 collimating laser beams irradiated from the semiconductor laser 501, into parallel beams, a wavelength filter 503 receiving a part of the parallel beams having passed through the lens 502, and a photodetector 504.

The photodetector 504 is designed to include a first light-receiving surface 505 at which a part of the parallel beams having passed through the lens 502 is directly received, and a second light-receiving surface 506 at which a part of the parallel beams having passed through the lens 502 and the wavelength-filter 503 is received.

As illustrated in FIG. 2, the first and second light-receiving surfaces 505 and 506 are both circular, and have centers located on a common horizontal line.

The semiconductor laser 501, the lens 502, the wavelength filter 503 and the photodetector 504 are arranged on a substrate (not illustrated).

The module 500 illustrated in FIG. 1 has an advantage that it is comprised of parts in a smaller number than a conventional module with high accuracy being maintained, but is accompanied with a problem as follows.

FIG. 3 is a graph showing a relation between an oscillation wavelength (axis of abscissas) of a semiconductor laser and a monitoring current (axis of ordinates) generated when a part of laser beams irradiated from the semiconductor laser is introduced into a light-receiving surface.

In FIG. 3, there are shown an optical-output monitoring current 600 generated when laser beams irradiated from a semiconductor laser is introduced directly into a light-receiving surface, and a wavelength-monitoring current 610 generated when laser beams irradiated from a semiconductor laser is introduced into a light-receiving surface through a wavelength filter, which is of an etalon type, for instance.

In the module 500 illustrated in FIG. 1, the first and second light-receiving surfaces 505 and 506 are arranged adjacent to each other on a substrate. By being arranged in a common substrate, each of the first and second light-receiving surfaces 505 and 506 receives laser beams out of a center of the laser beams.

Hence, if the photodetector 504 includes the first and second light-receiving surfaces 505 and 506 both of which are not optimized with respect to a size, a shape and a location, it would not be possible to have an appropriate monitor current, resulting in that the relation as shown in FIG. 3 cannot be obtained.

In order to have an appropriate monitor current, there are two solutions in one of which the first and second light-receiving surfaces 505 and 506 are arranged close to each other, and in the other of which the first and second light-receiving surfaces 505 and 506 are designed to have an increased area. However, these solutions are accompanied with a problem, as follows.

If the first and second light-receiving surfaces 505 and 506 are arranged close to each other, that is, if a space between the first and second light-receiving surfaces 505 and 506 is reduced, there is generated a stray light including a light 507 derived from the parallel beam having reflected at a sidewall of the wavelength filter 503, and a light 508 derived from the parallel beam having entered the wavelength filter 503 and then reflected a plurality of times in the wavelength filter 503, as illustrated in FIG. 1.

Since an area 509 in which such a stray light is generated overlaps the first light-receiving surface 505 directly receiving the parallel beam which does not pass through the wavelength filter 503, the optical-output monitor current 600 would contain slight fluctuation. As a result, there is obtained such a graph as illustrated in FIG. 4. If an optical-output monitoring current 700 shown with a thick solid line is dependent on a wavelength, an optical output would be instable, and accordingly, a wavelength-monitoring current 710 would be fluctuated, resulting in deterioration in stability of an oscillation wavelength.

If a sidewall of the wavelength filter 503 is in parallel with an axis of the parallel beams, the above-mentioned problem of a stray light would not be caused, but it is quite difficult to arrange the wavelength filter 503 on a substrate such that a sidewall of the wavelength filter 503 is in parallel with an axis of the parallel beams.

If the first and second light-receiving surfaces 505 and 506 are designed to have an increased area, there would be caused a problem explained hereinbelow.

Light-transmission characteristic of the wavelength filter 503 is highly dependent on an incident angle of laser beams entering the wavelength filter 503. Hence, if a degree of parallelization of laser beams entering the wavelength filter 503 is reduced, and further if the first and second light-receiving surfaces 505 and 506 had a large area, there would be obtained light-transmission characteristic covering a wide angle, as illustrated in FIG. 5, because light-transmission characteristic of the wavelength filter 503 is dependent on a location at which the wavelength filter 503 detects laser beams passing therethrough.

For instance, it is assumed that laser beams enter the wavelength filter 503 at incident angles A, B, C, D and E. Light-transmission characteristics for the incident angles are different from one another. A sum of the five light-transmission characteristics can be obtained as a light-transmission characteristic of the wavelength-filter 503. As a result, as illustrated in FIG. 6, there cannot be obtained a monitoring current dependent on a wavelength which current is necessary for stabilizing a wavelength.

As having been explained, the above-mentioned two solutions make it possible to increase a monitoring current, but are accompanied with a problem that light-transmission characteristic necessary for stabilizing a wavelength is deteriorated.

Japanese Patent Application Publication No. 4-157780 has suggested an apparatus for stabilizing a frequency of a semiconductor laser. The apparatus is comprised of an etalon receiving laser beams irradiated from the semiconductor laser, and allowing the received laser beams to pass therethrough and transmitting the reflected laser beams, a first light-receiver receiving the laser beams having passed through the etalon, a second light-receiver receiving the laser beams having reflected at the etalon, a calculator which subtracts an output of the first light-receiver and an output of the second light-receiver from each other to generate an optical output-detecting signal, and an oscillation controller for controlling an optical oscillation frequency of the semiconductor laser such that the optical output-detecting signal has a zero level.

Japanese Patent Application Publication No. 2002-185075 has suggested an apparatus for stabilizing a wavelength of laser beams, including a first unit directly receiving a part of laser beams irradiated from a semiconductor laser, and converting the thus received laser beams into an electric signal, a wavelength filter directly receiving a part of the laser beams, and having a transmittance which varies in accordance with a wavelength of the received laser beams, a second unit receiving laser beams having passed through the wavelength filter, and converting the thus received laser beams into an electric signal, and a third unit preventing the laser beams irradiated to a sidewall of the wavelength filter from entering the first unit through the wavelength filter.

Japanese Patent Application Publication No. 2002-237651 has suggested a wavelength-monitoring apparatus including a cylindrical lens through which laser beams irradiated from a semiconductor laser pass, first and second photodetectors receiving the laser beams having passed through the cylindrical lens, and a wavelength filter located between the cylindrical lens and the first photodetector.

Japanese Patent Application Publication No. 2002-237652 has suggested a laser diode module including a laser diode forwardly and backwardly irradiating laser beams, first and second photodiodes located in parallel with each other such that they interrupt at least a part of the laser beams backwardly irradiated from the laser diode, an optical filter located between the laser diode and at least one of the first and second photodiodes, and providing a wavelength difference to the laser beams entering the first and second photodiodes, and a beam shaper located the laser diode and the optical filter for flattening a cross-section of the laser beams backwardly irradiated from the semiconductor laser.

### SUMMARY OF THE INVENTION

In view of the above-mentioned problems in the prior art, it is an object of the present invention to provide a unit for stabilizing a wavelength of laser beams irradiated from a semiconductor laser which unit is capable of being comprised of parts in a smaller number than a conventional unit, and providing a sufficient monitoring current by receiving laser beams irradiated from a semiconductor laser without deterioration of light-transmission characteristic necessary for stabilizing a wavelength.

It is also an object of the present invention to provide a module for stabilizing a wavelength of an optical signal in optical communication which module is capable of doing the same.

In one aspect of the present invention, there is provided a unit for stabilizing a wavelength of a light, including (a) a first light-receiver directly receiving a part of laser beams irradiated from a semiconductor laser, (b) a wavelength-filter directly receiving a part of the laser beams, and having a transmittance varying in accordance with a wavelength of the received laser beams, and (c) a second light-receiver receiving laser beams having passed through the wavelength-filter, wherein the first light-receiver has a first edge, and the second light-receiver has a second edge located in the vicinity of the first edge, and the first edge has a first linear portion and the second edge has a second linear portion extending in parallel with the first linear portion.

For instance, by processing signals transmitted from the first and second light-receivers, a control signal is generated for stabilizing a wavelength of laser beams irradiated from a semiconductor laser. The control signal is fed back to the semiconductor laser. If the semiconductor laser is designed to include a temperature controller for controlling a temperature of the semiconductor laser, the control signal is fed back to at least one of the semiconductor laser and the temperature controller. As a result, the semiconductor laser can irradiate laser beams having a desired standard wavelength.

For instance, each of the first and second light-receivers may be a part of a photodetector mounted on a substrate, in which case, the first light-receiver may have a first light-receiving surface coextensive in a plane perpendicular to the substrate, and the second light-receiver may have a second light-receiving surface coextensive in the plane.

For instance, the first and second linear portions may extend in parallel with the substrate, or perpendicularly to the substrate.

The first and second light-receivers may be arranged on a common substrate.

This reduces a number of parts constituting the unit, and hence, reduces fabrication cost of the unit.

The photodetector may be designed to include the first and second light-receivers by one or more.

There is further provided a unit for stabilizing a wavelength of a light, including (a) a device collimating laser beams irradiated from a semiconductor laser, into parallel beams, (b) a first light-receiver directly receiving a part of the parallel beams, (c) a wavelength-filter directly receiving a part of the parallel beams, and having a transmittance varying in accordance with a wavelength of the received laser beams, and (d) a second light-receiver receiving the parallel beams having passed through the wavelength-filter, wherein the first light-receiver has a first edge, and the second light-receiver has a second edge located in the vicinity of the first edge, and the first edge has a first linear portion and the second edge has a second linear portion extending in parallel with the first linear portion.

For instance, the device may be comprised of a lens, in which case, it is preferable that the parallel beams have a ±2 degrees of parallelization or smaller.

The device minimizes harmful influence exerted on light-transmission characteristic of the wavelength filter, caused by an incident angle of laser beams dependent on a location at which laser beams enter the wavelength filter, and makes it possible to stabilize a wavelength of laser beams wit high accuracy.

In another aspect of the present invention, there is provided a module for stabilizing a wavelength of an optical signal in optical communication, including (a) a semiconductor laser forwardly irradiating signal laser beams, (b) a temperature controller which controls a temperature of the semiconductor laser, and (c) a unit which receives laser beams which the semiconductor laser backwardly irradiates, and stabilizes a wavelength of the received laser beams, wherein the unit is comprised of any one of the above-mentioned units for stabilizing a wavelength of a light.

It is preferable that the semiconductor laser is integrated to a device together with a field-absorption type semiconductor optical modulator.

By integrating the semiconductor laser together with a field-absorption type semiconductor optical modulator, it would be possible to simplify an optical communication system in structure in comparison with a conventional system in which a DFB laser and an external modulator are arranged in separate modules.

It is preferable that the module further includes a second temperature controller which controls a temperature of the unit independently of a temperature of the semiconductor laser.

For instance, the module may be designed to further include a first substrate on which on which the semiconductor laser and the temperature controller are mounted, and a second substrate on which the unit and the second temperature controller are mounted.

If the wavelength filter has a characteristic dependent on a temperature of the wavelength filter, it would be possible to control a temperature of the unit independently of a temperature of the semiconductor laser by designing the module to include the above-mentioned first and second substrates. Thus, it is possible to prevent the wavelength filter from being influenced by variance in a temperature of the semiconductor laser.

There is further provided a module for stabilizing a wavelength of an optical signal in optical communication, including (a) a semiconductor laser irradiating signal laser beams, (b) a temperature controller which controls a temperature of the semiconductor laser, (c) a beam splitter which splits the signal laser beams, and (d) a unit which receives a part of the signal laser beams having been split by the beam splitter, and stabilizes a wavelength of the received signal laser beams, wherein the unit is comprised of any one of the above-mentioned units for stabilizing a wavelength of a light.

The module makes it possible not to use laser beams backwardly irradiated from a semiconductor laser, which ensures that the unit is no longer necessary to include a device for collimating laser beams into parallel beams. Thus, it is possible to reduce a number of parts constituting the module, and reduce fabrication cost of the module.

The advantages obtained by the aforementioned present invention will be described hereinbelow.

The unit for stabilizing a wavelength of a light and the module for stabilizing a wavelength of an optical signal in optical communication both in accordance with the present invention are designed to include the first light-receiver having a first edge and the second light-receiver having a second edge located in the vicinity of the first edge, wherein the first edge has a first linear portion and the second edge has a second linear portion extending in parallel with the first linear portion. The first and second linear portions extending in parallel with each other reduce slight fluctuation in an optical-output monitoring signal which fluctuation is caused by reflection in the wavelength filter and at a sidewall of the wavelength filter, ensuring stable optical output and stable wavelength-current characteristic, and hence, ensuring stabilizing an oscillation wavelength of laser beams irradiated from a semiconductor laser.

Furthermore, the unit and the module both in accordance with the present invention can receive an optically densified portion in laser beams irradiated from a semiconductor laser, without loss, ensuring a monitoring current sufficient for stabilizing a wavelength of laser beams. As a result, it is possible to increase a monitoring current and enhance wavelength-current characteristic.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is an upper plan view of a conventional unit for stabilizing a wavelength of laser beams.

FIG. 2 is a front view of the first and second light-receiving surfaces in the unit illustrated in FIG. 1.

FIG. 3 is a graph showing a relation between an oscillation wavelength (axis of abscissas) of a semiconductor laser and a monitoring current (axis of ordinates) generated when a part of laser beams irradiated from a semiconductor laser is introduced into a light-receiving surface.

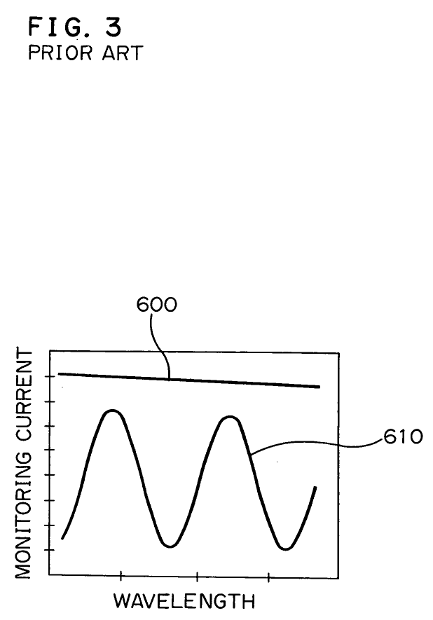

FIG. 4 is a graph showing fluctuation in an optical-output monitoring current.

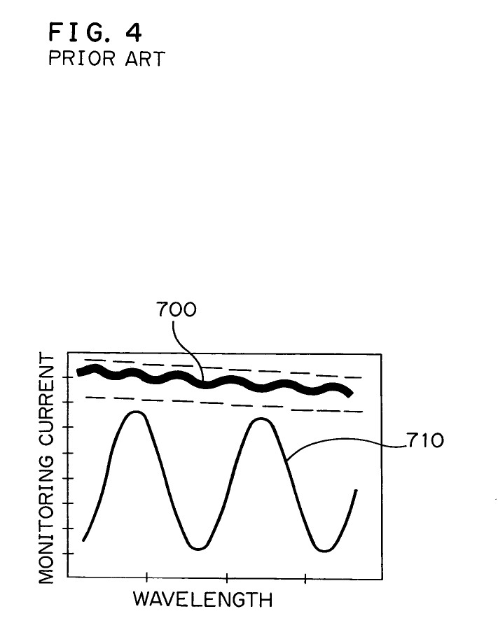

FIG. 5 is a graph showing light-transmission characteristic of a filter which is dependent on an incident angle of laser beam entering the filter.

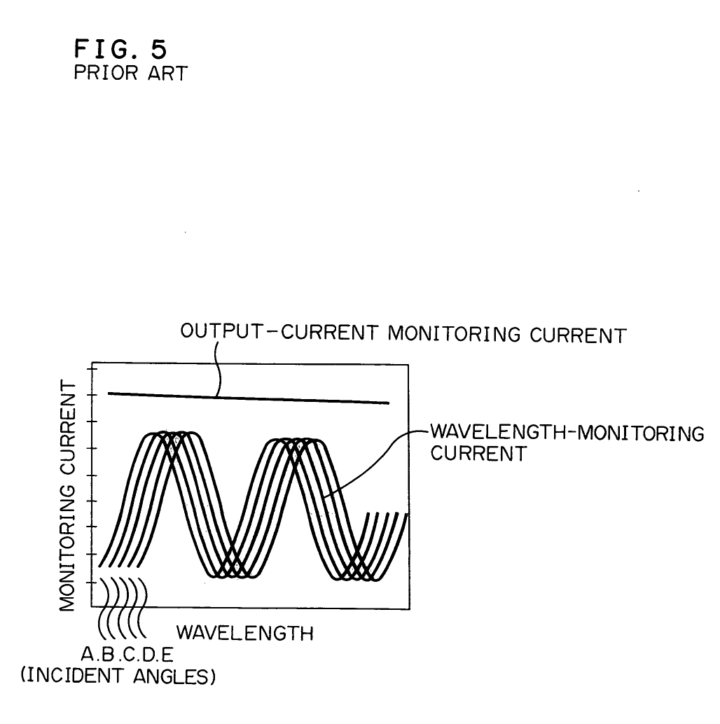

FIG. 6 is a graph showing a sum of light-transmission characteristics for a plurality of incident angles.

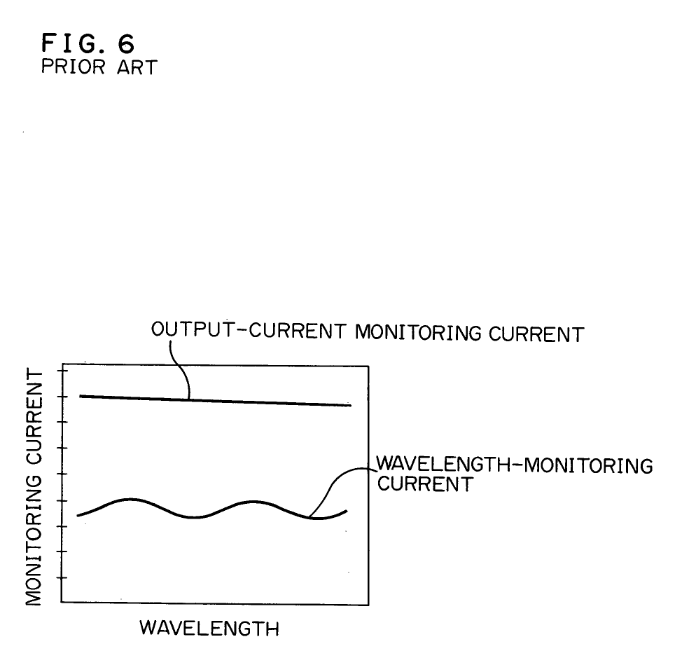

FIG. 7 is an upper plan view of a unit for stabilizing a wavelength of laser beams, in accordance with the first embodiment of the present invention.

FIG. 8 is a front view of the first and second light-receiving surfaces in the unit in accordance with the first embodiment, illustrated in FIG. 7.

FIG. 9 is a front view of the first and second light-receiving surfaces in the unit in accordance with a variant of the first embodiment.

FIG. 10 is an upper plan view of a unit for stabilizing a wavelength of laser beams, in accordance with the second embodiment of the present invention.

FIG. 11 is an upper plan view of a module for stabilizing a wavelength of an optical signal in optical communication, in accordance with the third embodiment of the present invention.

FIG. 12 is an upper plan view of a module for stabilizing a wavelength of an optical signal in optical communication, in accordance with the fourth embodiment of the present invention.

FIG. 13 is an upper plan view of a module for stabilizing a wavelength of an optical signal in optical communication, in accordance with the fifth embodiment of the present invention.

### DESCRIPTION OF THE PREFERRED EMBODIMENTS

Preferred embodiments in accordance with the present invention will be explained hereinbelow with reference to drawings.

[First Embodiment]

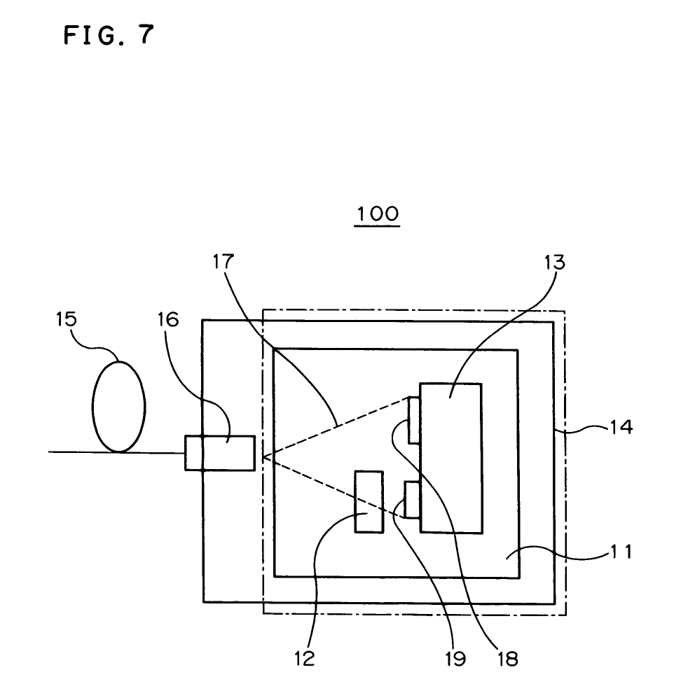

FIG. 7 is an upper plan view of a unit 100 for stabilizing a wavelength of laser beams, in accordance with the first embodiment of the present invention.

The unit 100 is comprised of a substrate 11, a wavelength filter 12 mounted on the substrate 11, a photodetector 13 mounted on the substrate 11, and a case 14 mounted on the substrate 11 for accommodating the wavelength filter 12 and the photodetector 13 therein.

A semiconductor laser (not illustrated) as a part of another module irradiates laser beams into the unit 100 through an optical fiber 15. Specifically, the laser beams are introduced to an irradiation point 16 through the optical fiber 15, and then, are irradiated into the unit 100 as laser beams 17.

The wavelength filter 12 has a transmittance defined as a ratio at which laser beams having entered the wavelength filter leave. The wavelength filter 12 directly receives a part of the laser beams 17, and the transmittance of the wavelength filter 12 varies in accordance with a wavelength of the received laser beams 17.

The photodetector 13 includes a first light-receiving surface 18 through which a part of the laser beams 17 is directly received, and a second light-receiving surface 19 through which laser beams having passed through the wavelength filter 12 are received. The first and second light-receiving surfaces 18 and 19 are arranged in a plane perpendicular to the substrate 11.

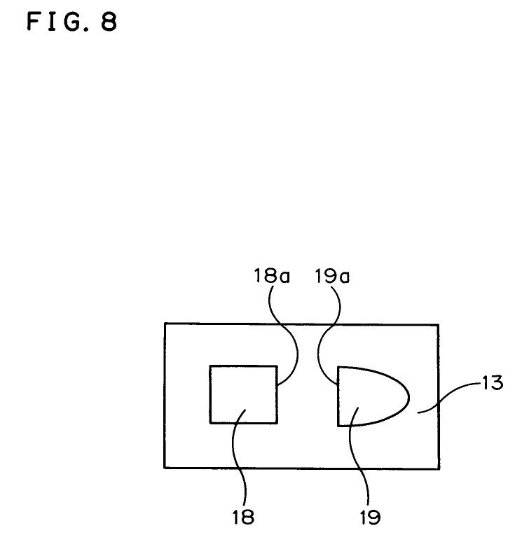

FIG. 8 is a front view of the first and second light-receiving surfaces 18 and 19.

As illustrated in FIG. 8, the first light-receiving surface 18 has a first edge 18a, and the second light-receiving surface 19 has a second edge 19a located in the vicinity of the first edge 18a. The first and second edges 18a and 19a are arranged in parallel with each other and perpendicularly to the substrate 11.

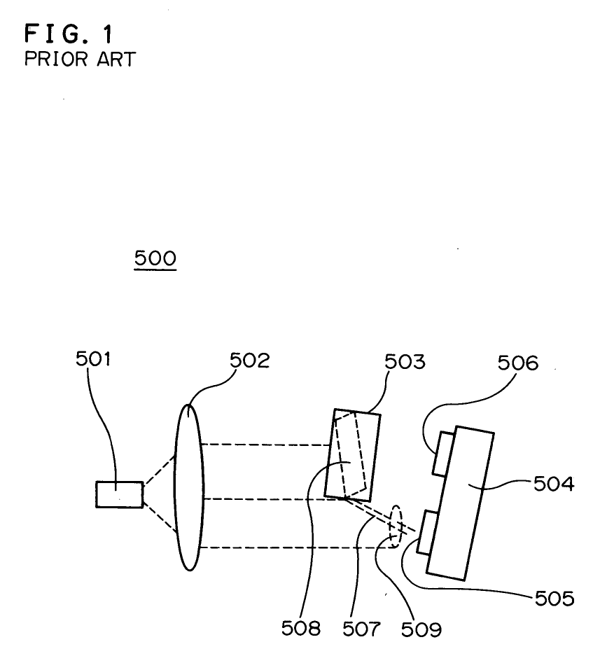

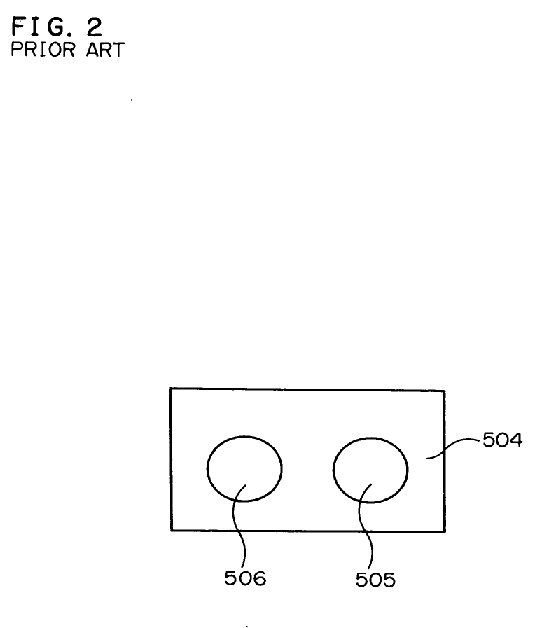

In accordance with the unit 100, since the first and second light-receiving surfaces 18 and 19 are designed to have the first and second edges 18a and 19a extending in parallel with each other, it is possible to avoid the area 509 (see FIG. 1) in which a stray light is generated, unlike the conventional light-receiving surfaces 505 and 506 illustrated in FIG. 2, and thus, the first and second light-receiving surfaces 18 and 19 can receive an optically densified portion of the laser beams 17. As a result, the unit 100 can prevent fluctuation in the optical-output current 600, and can have a sufficient monitoring current.

Furthermore, the photodetector 13 can be arranged in a larger area in which the unit 100 can have a sufficient monitoring current than an area in which the conventional photodetector 504 was arranged.

It should be noted that the unit 100 in accordance with the first embodiment is not to be limited to the above-mentioned structure. On the contrary, various modifications may be applied to the unit 100 in accordance with the first embodiment.

In the first embodiment, the first edge 18a of the first light-receiving surface 18 and the second edge 19a of the second light-receiving surface 19 are designed to be in parallel with each other over an entire length thereof. However, the first and second edges 18a and 19a may be designed to partially have a linear portion, in which case, the linear portions of the first and second edges 18a and 19a are arranged in parallel with each other.

As illustrated in FIG. 8, in the first embodiment, the first light-receiving surface 18 is formed square, and the second light-receiving surface 19 is formed half-oval. The first and second light-receiving surfaces 18 and 19 are not to be limited to those shapes. They may be designed to have any shape, unless they can be designed to have the first and second edges 18a and 19a extending in parallel with each other.

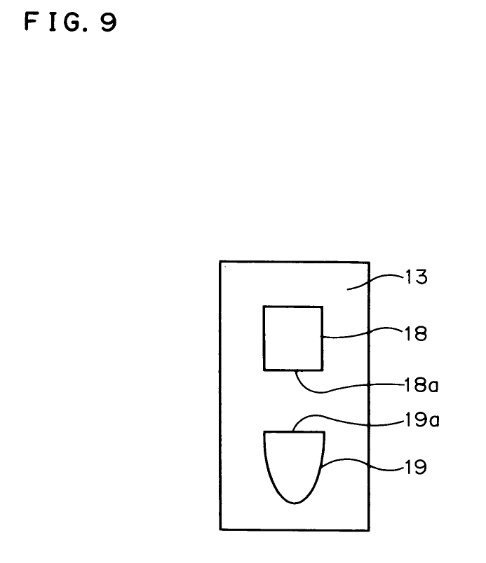

In the unit 100 in accordance with the first embodiment, the first and second edges 18a and 19a are arranged perpendicularly to the substrate 11. As an alternative, as illustrated in FIG. 9, the first and second edges 18a and 19a may be arranged in parallel with the substrate 11. The unit including the first and second edges 18a and 19a arranged in parallel with the substrate 11 provides the same advantages as obtained by the unit 100 in accordance with the first embodiment.

In the unit 100 in accordance with the first embodiment, the photodetector 13 is designed to include one pair of the first and second light-receiving surfaces 18 and 19. The number of a pair of the first and second light-receiving surfaces 18 and 19 is not to be limited to one. The photodetector 13 may be designed to include two or more pairs of the first and second light-receiving surfaces 18 and 19.

[Second Embodiment]

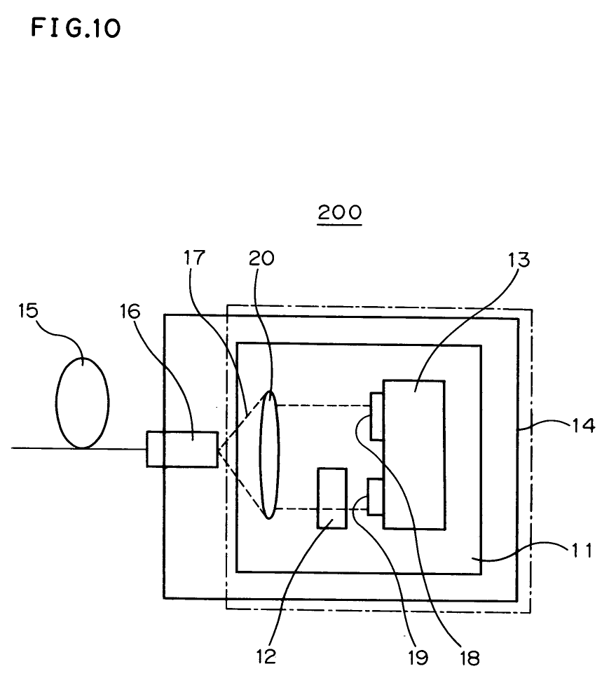

FIG. 10 is an upper plan view of a unit for stabilizing a wavelength of laser beams, in accordance with the second embodiment of the present invention.

The unit 200 in accordance with the second embodiment additionally includes a lens 20 for collimating the laser beams 17 into parallel beams, in comparison with the unit 100 in accordance with the first embodiment. The unit 200 has the same structure as that of the unit 100 except additionally including the lens 20. Hence, parts or elements that correspond to those of the unit 100 illustrated in FIG. 7 have been provided with the same reference numerals, and operate in the same manner as corresponding parts or elements in the first embodiment, unless explicitly explained.

The first light-receiving surface 18 directly receives a part of the parallel beams irradiated from the irradiation point 16 through the lens 20, and the rest of the parallel beams is introduced directly into the wavelength filter 12. The second light-receiving surface 19 receives the parallel beams having passed through the wavelength filter 12.

The lens 20 is selected among lenses which enable the parallel beams to have a ±2 degrees of parallelization or smaller.

Since the unit 200 in accordance with the second embodiment is designed to include the lens 20 which collimates the laser beams 17 into parallel beams, it is possible to minimize harmful influence acting on the light-transmission characteristic of the wavelength filter 12 which influence is caused by the dependency of an incident angle of the laser beams on a location at which the laser beams enter the wavelength filter 12. Thus, a wavelength of the laser beams can be stabilized wit high accuracy.

[Third Embodiment]

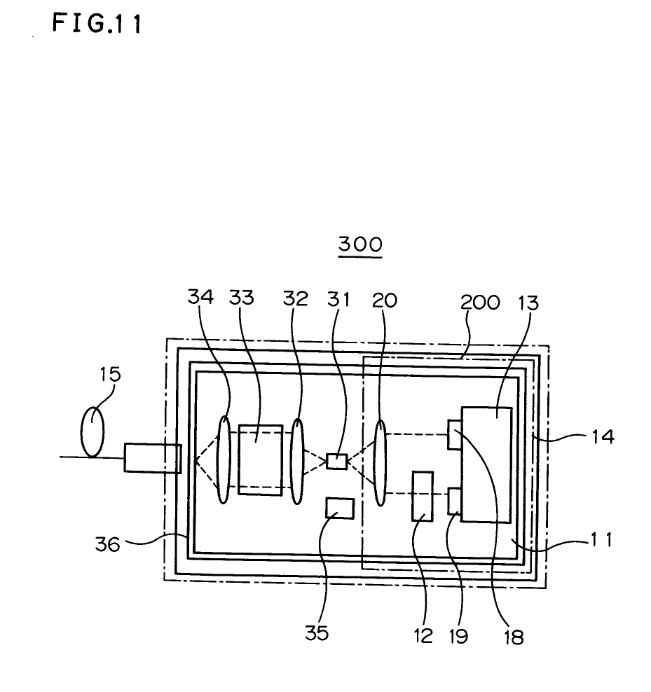

FIG. 11 is an upper plan view of a module 300 for stabilizing a wavelength of an optical signal in optical communication, in accordance with the third embodiment of the present invention.

The module 300 is comprised of the unit 200 in accordance with the second embodiment, illustrated in FIG. 10, a semiconductor laser module, a thermister thermometer 35 which detects a temperature of the substrate 11, and a temperature controller 36.

The semiconductor laser module is mounted on the substrate 11 which is a part of the unit 200, and is comprised of a semiconductor laser 31, a first lens 32 which collimates laser beams irradiated from the semiconductor laser 31, into parallel beams, an optical isolator 33 receiving the laser beams irradiated from the semiconductor laser 31 through the first lens 32, and a second lens 34 receiving the parallel beam having passed through the optical isolator 33, and forwarding signal beams to the optical fiber 15 for optical communication.

The thermister thermometer 35 is mounted on the substrate 11 for detecting a temperature of the substrate 11.

The temperature controller 36 keeps all of the optical parts mounted on the substrate 11, at a constant temperature. Specifically, the temperature controller 36 keeps the wavelength filter 12, the photodetector 13, the lens 20, the semiconductor laser 31, the first lens 32, the optical isolator 33 and the second lens 34 at a constant temperature

The all of the optical parts mounted on the substrate 11 is accommodated in the case 14.

The first and second light-receiving surfaces 18 and 19 of the photodetector 13 receive laser beams backwardly irradiated from the semiconductor laser 31. The temperature controller 36 controls a temperature of the semiconductor laser 31 during the semiconductor laser 31 operates.

In the module 300, as the semiconductor laser 31 is used a semiconductor laser into which a field-absorption type semiconductor modulator is integrated. By using such a semiconductor laser, it is possible to construct an optical communication system more compact than a system including a semiconductor laser and an external modulator formed as separate modules.

Since the module 300 is designed to include the unit 200 illustrated in FIG. 10, the module 300 provides the same advantages as the advantages obtained by the unit 200.

[Fourth Embodiment]

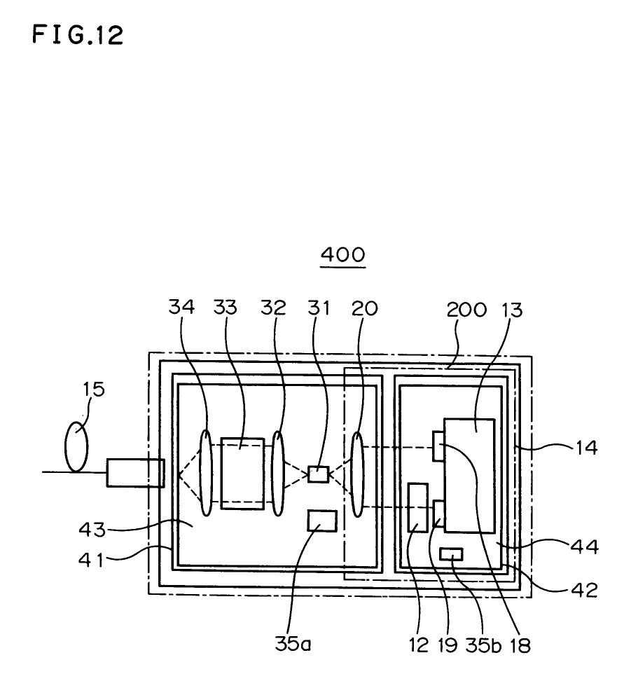

FIG. 12 is an upper plan view of a module 400 for stabilizing a wavelength of an optical signal in optical communication, in accordance with the fourth embodiment of the present invention.

The module 400 is designed to include a first substrate 41 on which the lens 20, the semiconductor laser 31, the first lens 32, the optical isolator 33, the second lens 34 and a thermister thermometer 35a, and a second substrate 42 on which the wavelength filter 12, the photodetector 13 and a thermister thermometer 35b.

A first temperature controller 43 is mounted on the first substrate 41 for keeping the optical parts mounted on the first substrate 41, at a constant temperature. Similarly, a second temperature controller 44 is mounted on the second substrate 42 for keeping the optical parts mounted on the second substrate 42, at a constant temperature.

That is, the module 400 includes the same parts as the parts constituting the module 300 in accordance with the third embodiment, but the parts constituting the module 400 are arranged on the two substrates 41 and 42 unlike the parts constituting the module 300, arranged on a single substrate.

As mentioned above, the semiconductor laser 31 is mounted on the first substrate 41, and the wavelength filter 12 is mounted on the second substrate 42. This arrangement ensures that the wavelength filter 12 having a characteristic influenced by temperature can be controlled independently of the semiconductor laser 31 with respect to temperature, and hence, it is possible to prevent the wavelength filter 12 from being influenced by variance in a temperature of the semiconductor laser 31.

[Fifth Embodiment]

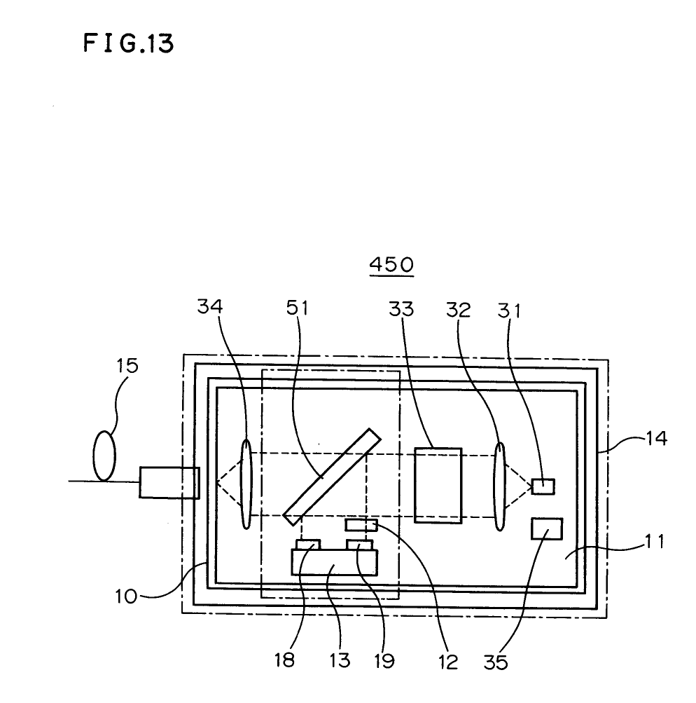

FIG. 13 is an upper plan view of a module 450 for stabilizing a wavelength of an optical signal in optical communication, in accordance with the fifth embodiment of the present invention.

The module 450 is structurally different from the module 300 illustrated in FIG. 11, as follows.

First, the module 450 is designed to include a beam splitter 51 in place of the lens 20. The beam splitter 51 splits the laser beams irradiated from the semiconductor laser 31, and is located on an optical path between the optical isolator 33 and the second lens 34.

Second, as a result that the module 450 includes the beam splitter 51 in place of the lens 20, the wavelength filter 12 and the photodetector 13 are located so as to receive signal beams having been split by the beam splitter 51. Hence, it is no longer necessary to use laser beams backwardly irradiated from the semiconductor laser 31, unlike the module 300 illustrated in FIG. 11.

As mentioned above, in the module 450 in accordance with the fifth embodiment, the laser beams irradiated from the semiconductor laser 31 is split by the beam splitter 51, and the thus split laser beam is received by the first and second light-receiving surfaces 18 and 19. In comparison with the module 300 in which laser beams backwardly irradiated from the semiconductor laser 31 is monitored, the module 450 is not necessary to include the lens 20 for collimating the laser beams backwardly irradiated from the semiconductor laser 31, ensuring reduction in both a number of parts constituting the module and fabrication costs of the module.

Though the module 450 in accordance with the fifth embodiment is based on the module 300 illustrated in FIG. 11, the module 450 may be designed based on the module 400 illustrated in FIG. 12.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2003-036899 filed on Feb. 14, 2003 including specification, claims, drawings and summary is incorporated herein by reference in its entirety.

What is claimed is:

1. A unit for stabilizing a wavelength of a light, comprising:
(a) a first light-receiver directly receiving a part of laser beams irradiated from a semiconductor laser;
(b) a wavelength-filter directly receiving a part of said laser beams, and having a transmittance varying in accordance with a wavelength of the received laser beams; and
(c) a second light-receiver receiving laser beams having passed through said wavelength-filter,
wherein said first light-receiver has a first edge, and said second light-receiver has a second edge located in the vicinity of said first edge, and
said first edge has a first linear portion and said second edge has a second linear portion extending in parallel with said first linear portion.

2. The unit as set forth in claim 1, wherein each of said first and second light-receivers is a part of a photodetector mounted on a substrate, said first light-receiver having a first light-receiving surface coextensive in a plane perpendicular to said substrate, said second light-receiver having a second light-receiving surface coextensive in said plane.

3. The unit as set forth in claim 2, wherein said first and second linear portions extend in parallel with said substrate.

4. The unit as set forth in claim 2, wherein said first and second linear portions extend perpendicularly to said substrate.

5. The unit as set forth in claim 1, wherein each of said first and second light-receivers is a part of a photodetector, and said photodetector includes said first and second light-receivers by one or more.

6. A unit for stabilizing a wavelength of a light, comprising:
(a) a device collimating laser beams irradiated from a semiconductor laser, into parallel beams;
(b) a first light-receiver directly receiving a part of said parallel beams;
(c) a wavelength-filter directly receiving a part of said parallel beams, and having a transmittance varying in accordance with a wavelength of the received laser beams; and
(d) a second light-receiver receiving said parallel beams having passed through said wavelength-filter,
wherein said first light-receiver has a first edge, and said second light-receiver has a second edge located in the vicinity of said first edge, and
said first edge has a first linear portion and said second edge has a second linear portion extending in parallel with said first linear portion.

7. The unit as set forth in claim 6, wherein said device is comprised of a lens.

8. The unit as set forth in claim 6, wherein said parallel beams have a 12 degrees of parallelization or smaller.

9. The unit as set forth in claim 6, wherein each of said first and second light-receivers is a part of a photodetector mounted on a substrate, said first light-receiver having a first light-receiving surface coextensive in a plane perpendicular to said substrate, said second light-receiver having a second light-receiving surface coextensive in said plane.

10. The unit as set forth in claim 9, wherein said first and second linear portions extend in parallel with said substrate.

11. The unit as set forth in claim 9, wherein said first and second linear portions extend perpendicularly to said substrate.

12. The unit as set forth in claim 6, wherein each of said first and second light-receivers is a part of a photodetector, and said photodetector includes said first and second light-receivers by one or more.

13. A module for stabilizing a wavelength of an optical signal in optical communication, comprising:
(a) a semiconductor laser forwardly irradiating signal laser beams;
(b) a temperature controller which controls a temperature of said semiconductor laser; and
(c) a unit which receives laser beams which said semiconductor laser backwardly irradiates, and stabilizes a wavelength of the received laser beams,
wherein said unit is comprised of:
(c1) a first light-receiver directly receiving a part of laser beams irradiated from a semiconductor laser;
(c2) a wavelength-filter directly receiving a part of said laser beams, and having a transmittance varying in accordance with a wavelength of the received laser beams; and
(c3) a second light-receiver receiving laser beams having passed through said wavelength-filter,
wherein said first light-receiver has a first edge, and said second light-receiver has a second edge located in the vicinity of said first edge, and
said first edge has a first linear portion and said second edge has a second linear portion extending in parallel with said first linear portion.

14. The module as set forth in claim 13, wherein said semiconductor laser is integrated to a device together with a field-absorption type semiconductor optical modulator.

15. The module as set forth in claim 13, further including a second temperature controller which controls a temperature of said unit independently of a temperature of said semiconductor laser.

16. The module as set forth in claim 15, further including a first substrate on which on which said semiconductor laser and said temperature controller are mounted, and a second substrate on which said unit and said second temperature controller are mounted.

17. The module as set forth in claim 13, wherein said unit further includes a device collimating said laser beams irradiated from said semiconductor laser, into parallel beams, wherein said first light-receiver directly receives a part of said parallel beams, and said wavelength-filter directly receives a part of said parallel beams.

18. The module as set forth in claim 17, wherein said device is comprised of a lens.

19. The module as set forth in claim 17, wherein said parallel beams have a ±2 degrees of parallelization or smaller.

20. The module as set forth in claim 13, wherein each of said first and second light-receivers is a part of a photodetector mounted on a substrate, said first light-receiver having a first light-receiving surface coextensive in a plane perpendicular to said substrate, said second light-receiver having a second light-receiving surface coextensive in said plane.

21. The module as set forth in claim 20, wherein said first and second linear portions extend in parallel with said substrate.

22. The module as set forth in claim 20, wherein said first and second linear portions extend perpendicularly to said substrate.

23. The unit as set forth in claim 13, wherein each of said first and second light-receivers is a part of a photodetector, and said photodetector includes said first and second light-receivers by one or more.

24. A module for stabilizing a wavelength of an optical signal in optical communication, comprising:
(a) a semiconductor laser irradiating signal laser beams;
(b) a temperature controller which controls a temperature of said semiconductor laser;
(c) a beam splitter which splits said signal laser beams, and
(d) a unit which receives a part of said signal laser beams having been split by said beam splitter, and stabilizes a wavelength of the received signal laser beams,
wherein said unit is comprised:
(c1) a first light-receiver directly receiving a part of laser beams irradiated from a semiconductor laser;
(c2) a wavelength-filter directly receiving a part of said laser beams, and having a transmittance varying in accordance with a wavelength of the received laser beams; and
(c3) a second light-receiver receiving laser beams having passed through said wavelength-filter,
wherein said first light-receiver has a first edge, and said second light-receiver has a second edge located in the vicinity of said first edge, and
said first edge has a first linear portion and said second edge has a second linear portion extending in parallel with said first linear portion.

25. The module as set forth in claim 24, wherein said semiconductor laser is integrated to a device together with a field-absorption type semiconductor optical modulator.

26. The module as set forth in claim 24, further including a second temperature controller which controls a temperature of said unit independently of a temperature of said semiconductor laser.

27. The module as set forth in claim 26, further including a first substrate on which on which said semiconductor laser and said temperature controller are mounted, and a second substrate on which said unit and said second temperature controller are mounted.

28. The module as set forth in claim 24, wherein said unit further includes a device collimating said laser beams irradiated from said semiconductor laser, into parallel beams, wherein said first light-receiver directly receives a part of said parallel beams, and said wavelength-filter directly receives a part of said parallel beams.

29. The module as set forth in claim 28, wherein said device is comprised of a lens.

30. The module as set forth in claim 28, wherein said parallel beams have a±2 degrees of parallelization or smaller.

31. The module as set forth in claim 24, wherein each of said first and second light-receivers is a part of a photodetector mounted on a substrate, said first light-receiver having a first light-receiving surface coextensive in a plane perpendicular to said substrate, said second light-receiver having a second light-receiving surface coextensive in said plane.

32. The module as set forth in claim 31, wherein said first and second linear portions extend in parallel with said substrate.

33. The module as set forth in claim 31, wherein said first and second linear portions extend perpendicularly to said substrate.

34. The unit as set forth in claim 24, wherein each of said first and second light-receivers is a part of a photodetector, and said photodetector includes said first and second light-receivers by one or more.
